(19) United States
(12) Patent Application Publication
(10) Pub. No.: US 2021/0199045 A1
(43) Pub. Date: Jul. 1, 2021

(54) A DUAL SPRING BLOW-OFF VALVE WITH IMPROVED AIR ASSISTANCE

(71) Applicant: PADMINI VNA MECHATRONICS PVT. LTD., GURGAON (IN)

(72) Inventors: KABIR BHANDARI, NEW DELHI (IN); AMARDIP KUMAR, GURGAON (IN); KUMAR ABHISHEK, Gurgaon (IN); PARSHURAM ROUT, Gurgaon (IN)

(21) Appl. No.: 17/056,838

(22) PCT Filed: May 20, 2019
(86) PCT No.: PCT/IB2019/054133

§ 371 Date: Nov. 19, 2020

(30) Foreign Application Priority Data
May 19, 2018 (IN) 201811018839

(51) Int. Cl. F02B 37/18; F16K 31/06

(52) U.S. Cl. CPC F02B 37/18; F16K 31/0655

(57) ABSTRACT

The present invention provides a blow-off valve for an internal combustion engine. More specifically, the invention provides a dual spring blow-off valve to improve air pressure management in the intake system of a turbocharged vehicle when the throttle is lifted or closed. The main object of the invention is to provide a dual spring blow-off valve to improve air pressure management in the intake system of a turbocharged vehicle when the throttle is lifted or closed.

### FIELD OF THE INVENTION

The present invention provides a blow-off valve assembly for an internal combustion engine. More specifically, the invention provides a dual spring blow-off valve to improve air pressure management in the intake system of a turbocharged vehicle when the throttle is lifted or closed.

### BACKGROUND OF THE INVENTION

Superchargers are utilized in internal combustion engines to increase volumetric efficiency of the engines and thereby to enhance the performance of the engines. When the throttle of such an engine closes during operation, certain detrimental effects can result. These include a build-up of pressure downstream of the throttle with a resultant undesirable increase in heat, a rapid deceleration of the supercharger compressor with a resultant increase in potentially damaging or wearing forces on the compressor, excessive and unpleasant noise effects and an increase in the ratio of fuel in the fuel/air mixture supplied to the engine which results in the engine running rich.

In an attempt to overcome these disadvantages, a blow-off valve may be provided downstream of the supercharger compressor outlet. A blow-off valve is a pressure release system present in most turbocharged engines that functions to prevent compressor surge and reduce wear on the turbocharger system and engine. Blow-off valves relieve the damaging effects of compressor “surge loading” by allowing the compressed air to vent to the atmosphere or to re-circulate into the intake upstream of the compressor inlet. In most cases the blow-off valves open a blow-off port to release the air under pressure in the surrounding atmosphere, thus prevent any damage to the compressor part.

Typically a blow-off valve is a safety mechanism on the turbo that ‘manages’ the boost produced by the turbo. The blow-off valve is actuated by a diaphragm which is controlled via solenoid. The solenoid itself is controlled by the engine management system having an electronic control unit (ECU). When the solenoid receives a signal from the ECU, to open the valves to bypass the gasses around the exhaust turbine in the turbo, it allows pressure to be maintained in a safe zone. Since a blow-off valve is a critical part for the safety of the machine it must be highly reliable. Besides, a blow-off valve should be capable to induce a pressure drop within nearly zero amount of time to avoid a longer duration of dangerous conditions. Therefore, blow-off valves should preferably be designed simple and robust. Since, the blow-off valve should be capable of inducing a pressure drop immediately, a blow-off valve must be capable for a very high flow rate in the opening position and therefore it is usually big in size. The fast actuation of a big free piston in the body of the valve needs a very powerful actuation of the valve, which must also be extremely reliable at the same time, it is required that it will not waste necessary pressure built at the entry. All these requirements of extreme operating conditions lead to expensiveness especially the actuation of the blow-off valve.

The advent of increasingly powerful engines and performance turbo charging systems, the demand for blow-off valves have increased exponentially. In existing blow off valve, in most cases opening time is higher or requires higher voltage to open/actuate pressure. Therefore, as we can deduce from the state of art that a blow-off valve is required for faster opening at minimum voltage application to open and/or actuate pressure mitigation.

### OBJECT OF THE INVENTION

The main object of the invention is to provide a dual spring blow-off valve assembly to improve air pressure management in the intake system of a turbocharged vehicle when the throttle is lifted or closed.

Yet another object of the invention is to improve the working of blow-off valve by improving the performance parameters like improvement of actuating voltage, improvement in opening response and operation or management in high input pressure.

### SUMMARY OF THE INVENTION

The present invention provides a blow-off valve for an internal combustion engine. More specifically, the invention provides a dual spring blow-off valve to improve air pressure management by providing an air path gap in the intake system of a turbocharged vehicle when the throttle is lifted or closed.

In an embodiment of the present invention, the dual spring blow-off valve provided comprises of an adjustable screw, a plunger body, a spring seat, a high load spring, a moving core, a low load spring, a magnetic spring guider, a fix core, a bobbin, coil, a coil housing, a plunger housing and terminals to power up the coil. The blow-off valve has an inlet for entry of air and an outlet for air release. The adjustable screw tightens into the moving core to modify the air path gap at the entry. The adjustable screw is made up of material such as, but not limited to like stainless steel, carbon steel, etc. The dual spring arrangement comprising of a low load spring helps in early blockage of air path gap by the help of primary movement of moving core and adjusting pin; and a high load spring helps to prevent the leakage through valve sealing area.

In another embodiment of the present invention, an over molded coil assembly is provided that includes a bobbin with a bore extending axially. Further, a metallic coil or conducting material is wound or wrapped around the bobbin, that upon energization sets up a magnetic field. At the distal end of bobbin, a fix core is attached to assemble a magnetic spring guider for low load spring. Further, the low load spring is co-axially inserted into the moving core at other end. At the one end, terminal pins are connected within bobbin to which coil's end are connected for receiving electrical input.

In another embodiment of the present invention, a plunger body is provided and a spring seat is fixed into the plunger body and secured inside a plunger housing with a high load spring. Further, the coil housing and plunger housing are press fitted and sealed to form a fully functional dual spring blow-off valve. The fix core provides a magnetic path to attract the moving core upward against the spring force of the high load and low load springs when coil is energized. When the coil is de-energized, the moving core is separated from the fixed core by the action of springs to return the spring seat in the opposite direction.

In another embodiment of the present invention, the provided dual spring blow-off valve has improved working of blow off valve by improving the performance parameters like actuating voltage, opening response time and high input pressure. The provided dual spring blow-off valve has faster opening time with minimum voltage required to open and/or actuate pressure mitigation because low load spring helps block the air entrance into the valve by the help of adjusting pin. Thus, the provided dual spring blow-off valve provides consistency of valve opening time with respect to the pressure.

In another embodiment of the present invention, the dual-spring blow-off valve comprises steps of fully closing dual spring blow-off valve with no voltage applied and an air path gap of 3 mm is maintained; fully closing air path gap in the blow off valve with no air gap as low load spring is functioning to close the air path gap; and fully opening valve by applying voltage to valve.

### BRIEF DESCRIPTION OF THE DRAWINGS

The object of the invention may be understood in more details and more particularly description of the invention briefly summarized above by reference to certain embodiments thereof which are illustrated in the appended drawings, which drawings form a part of this specification. It is to be noted, however, that the appended drawings illustrate preferred embodiments of the invention and are therefore not to be considered limiting of its scope, for the invention may admit to other equally effective equivalent embodiments.

FIG. 1 shows the sectional view of a dual spring blow-off valve in accordance with an embodiment of the present invention.

FIG. 2 shows the sectional view of a dual spring blow-off valve representing fully closed operation in accordance with an embodiment of the present invention.

FIG. 3 shows the sectional view of a dual spring blow-off valve representing air path gap blocking operation in accordance with an embodiment of the present invention.

FIG. 4 shows the sectional view of a dual spring blow-off valve representing fully open operation in accordance with an embodiment of the present invention.

FIG. 5 shows time response graph of a dual spring blow-off valve in accordance with an embodiment of the present invention.

### DETAILED DESCRIPTION OF THE INVENTION

The present invention will now be described more fully hereinafter with reference to the accompanying drawings in which a preferred embodiment of the invention is shown. This invention may, however, be embodied in many different forms and should not be construed as being limited to the embodiment set forth herein. Rather, the embodiment is provided so that this disclosure will be thorough, and will fully convey the scope of the invention to those skilled in the art.

In an embodiment of the present invention, the dual spring blow-off valve provided comprises of an adjustable screw, a plunger body, a spring seat, a high load spring, a moving core, a low load spring, a magnetic spring guider, a fix core, a bobbin, coil, a coil housing, a plunger housing and terminals to power up the coil. The blow-off valve has an inlet for entry of air and an outlet for air release. The adjustable screw tightens into the moving core to modify the air path gap at the entry. The adjustable screw is made up of material such as, but not limited to like stainless steel, carbon steel, etc.

In another embodiment of the present invention, an over molded coil assembly is provided that includes a bobbin formed from an electrically insulated material such as, thermoplastics, nylon, etc., with a bore extending axially. Further, a metallic coil or conducting material such as copper is then wound or wrapped around the bobbin, which when energized sets up a magnetic field. At the distal end of bobbin, a fix core is attached to assemble a magnetic spring guider for low load spring. The magnetic spring guider is made up of material, such as but not limited to like AISI 430F, etc. to increase the magnetic force. Further, low load spring is co-axially inserted into the moving core at other end. At the one end, terminal pins are connected with in bobbin to which coil's end are connected for receiving electrical input.

In another embodiment of the present invention, a plunger body is provided which is made up of material such as, but not limited to like thermoplastic, etc. and a spring seat made up of material such as, but not limited to like silicone, NBR, etc. is fixed into the plunger body and secured inside a plunger housing with a high load spring. Further, the coil housing and plunger housing are press fitted and sealed to form a fully functional dual spring blow-off valve. The fix core provides a magnetic path to attract the moving core upward against the spring force of the high load spring and low load springs when coil is energized. When the coil is de-energized, the moving core is separated from the fixed core by the action of springs to return the spring seat in the opposite direction.

In another embodiment of the present invention, the provided dual spring blow-off valve has improved working of blow off valve by improving the performance parameters like actuating voltage, opening response time and high input pressure. The provided dual spring blow-off valve has faster opening time with minimum voltage required to open and/or actuate pressure mitigation because low load spring helps block the air entrance into the valve by the help of adjusting pin. Thus, the provided dual spring blow-off valve provides consistency of valve opening time with respect to the pressure.

In another embodiment of the present invention, the spring arrangement provided in dual spring blow-off valve comprises of a low load spring that helps the early blockage of air path gap by the help of primary movement of moving core and adjusting pin; and a high load spring helps to prevent the leakage through valve sealing area.

In another embodiment of the present invention, the dual-spring blow-off valve comprises steps of fully closing dual spring blow-off valve with no voltage applied and maintaining an air path gap; fully closing air path gap in the blow off valve with no air path gap as low load spring is functioning to block the air path gap that helps in early blockage of air path by the help of primary movement of moving core and adjusting pin; and fully opening valve by applying voltage to valve.

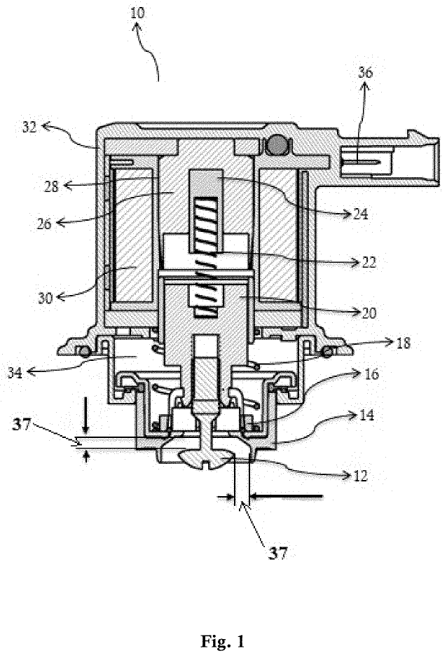

FIG. 1 shows a sectional view of a dual spring blow-off valve 10 comprising of an adjusting screw 12 that tightens into the moving core 20 to modify the air path gap 37 at the entry. The blow-off valve 10 has an inlet 38 for entry of air and an outlet 39 for air release. The adjustable screw 12 is made up of material such as, but not limited to like stainless steel, carbon steel, etc. A plunger body 14 is provided made up of material such as, but not limited to like thermoplastic, etc., and a spring seat 16 made up of material such as, but not limited to like silicone, NBR, etc. is fixed into the plunger body 14 and secured inside a plunger housing 34 with a high load spring 18. An over-molded coil assembly 32 is provided that includes a bobbin 28 formed from an electrically insulated material such as, thermoplastics, nylon, etc., with a bore extending axially. Further, a metallic coil 30 or conducting material such as copper is then wound or wrapped around the bobbin 28, which when energized sets up a magnetic field. At the distal end of bobbin 28, a fix core 26 is attached to assemble a magnetic spring guider 24 for low load spring 22. The magnetic spring guider 24 is made up of material, such as but not limited to like AISI 430F, etc. to increase the magnetic force. Further, low load spring 22 is co-axially inserted into the moving core 20 at other end. At the one end, terminal pins 36 are connected with in bobbin 28 to which coil's end are connected for receiving electrical input. Further, the coil housing 32 and plunger housing 34 are press fitted and sealed to form a fully functional dual spring blow-off valve 10. The provided fix core 26 provides a magnetic path to attract the moving core 20 upward against the spring force of the high load 18 and low load spring 22 when coil is energized. When the coil is de-energized, the moving core 20 is separated from the fixed core 26 by the action of springs to return the spring seat 16 in the opposite direction.

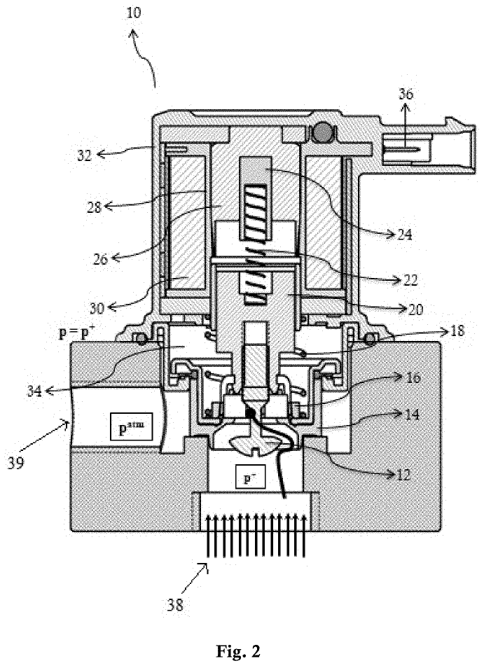

FIG. 2 shows the sectional view of a dual spring blow-off valve 10 representing fully closed operation wherein pressure (p⁺) at the inlet 38 of dual spring blow-off valve 10 is equivalent to pressure (p) inside the dual spring blow-off valve 10. In such case there is no voltage application and the nominal 3 mm air path gap 37 is maintained. The blow-off valve 10 prevents its blockage by dust particles coming from the air by maintaining the air path gap 37, while the pressure at inlet 38 is equivalent to pressure inside the said valve 10. Any change in the air path gap 37 affects the performance parameters like response time, actuating voltage, internal leakage etc.

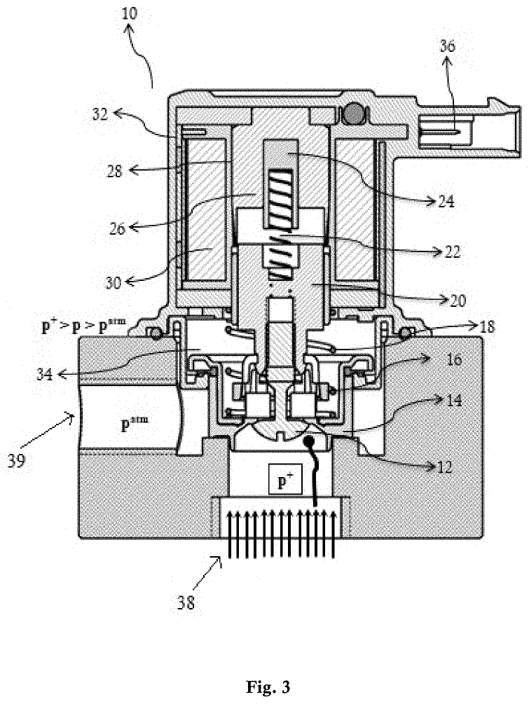

FIG. 3 shows the sectional view of a dual spring blow-off valve 10 representing air path gap 37 blocking operation wherein pressure (p+) at the inlet 38 of dual spring blow-off valve 10 is greater than pressure (p) inside the dual spring blow-off valve 10 and atmospheric pressure (p^{atm}). In such case dual spring blow-off valve 10 remains closed and there will be no air path gap 37 available thus prevents the leakage of pressure for a booster engine. The blow-off valve 10 prevents the leakage of pressure by closing the air path gap 37 while the pressure (p+) at inlet 38 is greater than the pressure (p) inside the valve 10 and atmospheric pressure (p^{atm}). This leakage prevention is achieved by low load spring 22 which oppose the pressure (p⁺) at the inlet 38 and keeps the air path gap 37 in closed condition.

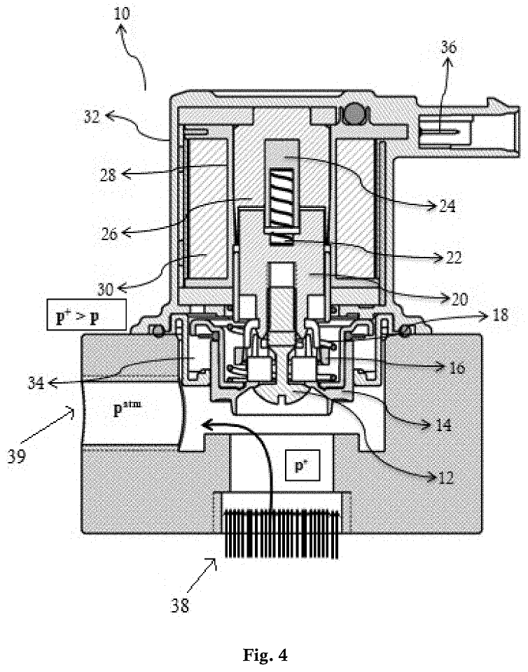

FIG. 4 shows the sectional view of a dual spring blow-off valve 10 representing fully open operation wherein pressure (p+) at the inlet 38 of dual spring blow-off valve 10 is greater than pressure (p) inside the dual spring blow-off valve 10 and to avoid any accident to booster, moving core 20 is pulled towards the fix core 26 by applying voltage to the dual spring blow-off valve 10. In this case excess air bleeds outside the dual spring blow-off valve 10 and allows the pressure to come to the atmospheric pressure (p^{atm}). Here, the dual spring blow-off valve 10 removes the excess air outside the valve 10 from outlet 39 while it is equal to the atmospheric pressure (p^{atm}) and the pressure (p+) at the inlet 38 is greater than pressure (p) inside the valve 10 and the moving core 20 is pulled towards the fix core 26.

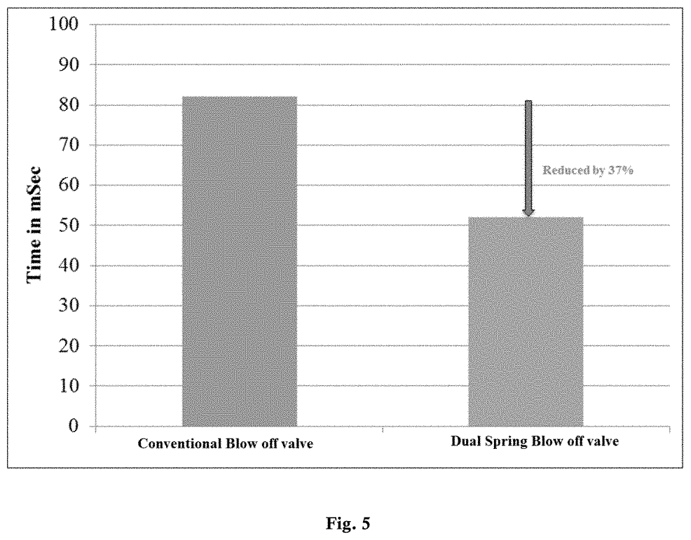

FIG. 5 shows time response graph of a dual spring blow-off valve 10 and a conventional blow off valve at a pressure of 180 kPa. From the opening response time graph it is established that an overall reduction of 37% is achieved in opening response time.

In another embodiment of the present invention, the dual spring blow-off valve is tested for various parameter likes valve leak amount, open time, close time, opening operation response, closing operation response, valve lift amount, coil resistance and inductance. It is established that dual spring blow-off valve has all these parameters within specification, as shown in Table 1.

TABLE 1
Dual spring blow-off valve parameters

| | | Dual Spring | | |
|---|---|---|---|---|
| | | Blow-off | | |
| | | valve (3 mm | | |
| Parameters | Design Requirements | air gap) | | Judgment |
| Valve leak | Initial 101 pm or less @ | 6.01 | pm | No changes in |
| amount | 25 ± 10° C., valve | | | performance |
| | pressure differential | | | |
| | 180 kPa | | | |
| Open time | 200 ms or less @ | 52 | ms | No changes in |
| | terminal current 0.93 A, | | | performance |
| | 120 kPa | | | |
| Opening | 40 ms or less @ | 26 | ms | No changes in |
| operation | terminal voltage 13 V, | | | performance |
| response | 20 C., @ 0 kPa | | | |
| Closing | 50 ms or less @ | 30 | ms | No changes in |
| operation | terminal voltage 13 V, | | | performance |
| response | 20° C., @ 0 kPa | | | |
| Valve lift | In installed state, initial | 5.4 | mm | Within |
| amount | 5.5 ± 0.35 mm, After | | | Specification |
| (Stroke) | endurance 5.6 ± 0.4 mm | | | mean value. |
| Coil | 8.9 ± 0.25 Ω @ 20° C. | 9.1 | Ω | Within |
| resistance(Rw) | | | | Specification. |
| Inductance(L) | 29.5 ± 3 mH @ 1 kHz, | 31.57 | mH | Within |
| | 20° C. | | | Specification |

Further, Table 2 below shows the improved characteristics of the dual spring blow off valve in comparison to a conventional blow-off valve with 1 mm air gap.

TABLE 2
Comparison of parameters of blow off valve
to a conventional blow off valve

| | Conventional | | Dual spring | | |
|---|---|---|---|---|---|
| | blow off | | blow off | | |
| | valve (1 mm | | valve (3 mm | | |
| Parameters | air gap) | | air gap) | | Remarks |
| Actuating | 9 | V | 8 | V | Low actuating voltage |
| Voltage | | | | | in dual spring design |
| Input | 120 | kPa | 180 | kPa | Dual spring design will |
| Pressure | | | | | work in high input |
| | | | | | pressure. |
| Open time | 82 | ms | 52 | ms | Improved open time in |
| | | | | | Dual spring design |
| Opening | 32 | ms | 26 | ms | Improved opening |
| operation | | | | | response time in Dual |
| response | | | | | spring design |
| Closing | 31 | ms | 30 | ms | Almost same closing |
| operation | | | | | operation response in |
| response | | | | | Dual spring design |

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

We claim:

1. A dual spring blow-off valve (10) assembly for improving air pressure management comprising of:
an adjustment screw (12), a plunger body (14), a spring seat (16), a high load spring (18), a moving core (20), a low load spring (22), a magnetic spring guider (24), a fix core (26), a bobbin (28), a coil (30), a coil housing (32), a plunger housing (34), and a plurality of terminal pins (36),
wherein,
said dual spring blow-off valve (10) is having an inlet (38) for air entry and an outlet (39) for air release;
said adjustment screw (12) tightens into the moving core (20) to adjust an air path gap (37) entering the dual spring blow off valve for air pressure management;
said low load spring (22) blocks the air path gap (37) by movement in said moving core (20) and said adjustment screw (12), while said high load spring (18) prevents leakage of air through the dual spring blow-off valve; and
said dual spring blow off valve exhibits low operating voltage, reduced opening and closing response time.

2. The dual spring blow-off valve (10) as claimed in claim 1 wherein, said dual spring blow-off valve (10) shows a 37% reduction in opening response time at an air pressure of 180 kPa.

3. The dual spring blow-off valve (10) as claimed in claim 1 wherein, said dual spring blow-off valve (10) shows an operating voltage of 8 V, opening response time of 26 ms and closing response time of 30 ms at an air path gap (37) of 3 mm.

4. The dual spring blow-off valve (10) as claimed in claim 1 wherein, said dual spring blow-off valve (10), prevents its blockage by dust particles by maintaining an air path gap (37) while the pressure at inlet (38) is equivalent to pressure inside the said valve (10).

5. The dual spring blow-off valve (10) as claimed in claim 1 wherein, said dual spring blow-off valve (10), prevents the leakage of pressure by closing the air path gap (37) while the pressure at the inlet (38) is greater than the pressure inside the valve (10) and atmospheric pressure.

6. The dual spring blow-off valve (10) as claimed in claim 1 wherein, said dual spring blow-off valve (10) removes excess air outside the valve (10) from the outlet (39) while it is equal to the atmospheric pressure and the pressure at the inlet (38) is greater than pressure inside the valve (10) and the moving core (20) is pulled towards the fix core (26).

7. The dual spring blow-off valve (10) as claimed in claim 5 wherein, the leakage of pressure is prevented by the low load spring (22) that opposes the pressure at inlet (38) and keeps the air path closed.

8. The dual spring blow-off valve (10) as claimed in claim 5 wherein, the magnetic spring guider (24) is made up of material including but not limited to like AISI 430F.
